(19) United States
(12) Patent Application Publication
(10) Pub. No.: US 2026/0152167 A1
(43) Pub. Date: Jun. 4, 2026

(54) METHOD AND APPARATUS FOR EMERGENCY BRAKING DURING AUTONOMOUS PARKING

(71) Applicants: Hyundai Motor Company, Seoul (KR); Kia Corporation, Seoul (KR)

(72) Inventor: Jun Yeol CHOI, Hwaseong-Si (KR)

(21) Appl. No.: 19/305,226

(22) Filed: Aug. 20, 2025

(30) Foreign Application Priority Data
Dec. 3, 2024 (KR) 10-2024-0177062

(51) Int. Cl. B60T 17/22; B60T 7/12; B60T 8/171; B60T 8/172; B60T 8/92; B60T 13/74; B60W 60/00; F16D 65/38

(52) U.S. Cl. CPC B60T 17/221; B60T 7/12; B60T 8/171; B60T 8/172; B60T 8/92; B60T 13/741; B60W 60/0015; F16D 65/38; B60T 2201/10; B60T 2201/12; B60T 2270/402; B60T 2270/403; B60T 2270/406; B60W 2510/182; B60W 2510/186; F16D 2065/386

(57) ABSTRACT

A method performed by an apparatus of a vehicle may comprise, based on receiving a start signal for autonomous parking or autonomous exit from parking of the vehicle, operating a motor in a brake-applying direction to move a brake pad of the vehicle into contact with a brake disc of the vehicle, stopping, based on a current supplied to the motor reaching a preset threshold value, the operating of the motor, wherein the preset threshold value corresponds to a state at which the brake pad contacts the brake disc, and operating the motor in a brake-releasing direction until the brake pad is spaced apart from the brake disc by a preset clearance gap that is smaller than a reference clearance gap.

### CROSS-REFERENCE TO RELATED APPLICATION

The present application claims the benefit of priority to Korean Patent Application No. 10-2024-0177062, filed in the Korean Intellectual Property Office on Dec. 3, 2024, the entire contents of which are incorporated herein for all purposes by reference.

### TECHNICAL FIELD

The present disclosure relates to a method and an apparatus for emergency braking during autonomous parking. More specifically, it relates to a technique for pre-adjusting a clearance between a brake pad and a brake disc for emergency braking using an electronic parking brake during autonomous parking.

### BACKGROUND

The matters described in this Background section are only for enhancement of understanding of the background of the disclosure, and should not be taken as acknowledgment that they correspond to prior art already known to those skilled in the art.

A brake system is used to decelerate and/or stop a vehicle, and is also used to keep the vehicle parked. The brake system generally employs a friction-type brake which converts kinetic energy into thermal energy by using frictional force to perform braking. The friction-type brake may fulfill a braking function by pressing brake pads against both sides of a brake disc rotating together with a wheel.

An autonomous parking system enables the vehicle to be automatically parked without human intervention. The autonomous parking system may plan a parking path using data collected from sensors or the like of the vehicle, and may guide the vehicle in a parking space safely. Specifically, the autonomous parking system may detect a surrounding environment, and recognize a parking space using wide-angle cameras and ultrasonic sensors which are mounted on the vehicle. Based on recognized parking space information, the autonomous parking system may calculate a current location and a target position of the vehicle, and control the vehicle to complete parking.

If a primary braking system of the vehicle fails or obstacle recognition is delayed during autonomous parking, a risk of collision may increase. To prevent this, the autonomous parking system may operate at a low driving speed. However, due to the low driving speed during the autonomous parking, it may take a longer time for the vehicle to reach its destination, and the vehicle may interfere with the traffic flow of other vehicles.

In the event of a failure in the primary braking system (e.g., a hydraulic brake) during autonomous parking, emergency braking may be performed using an auxiliary braking system (e.g., an EPB, an EMB, or the like). However, systems such as EPB (Electronic Parking Brake) and EMB (Electro-Mechanical Brake), which use electric motors, may have a slower braking response speed compared to hydraulic brakes.

### SUMMARY

The present disclosure is directed to providing a method and an apparatus for pre-adjusting a clearance between a brake pad and a brake disc for emergency braking using an electronic parking brake during autonomous parking.

The problems to be solved by the present disclosure are not limited to those mentioned above, and other problems not mentioned herein will be clearly understood by those skilled in the art from the following description.

According to the present disclosure, a method performed by an apparatus of a vehicle, the method may comprise based on receiving a start signal for autonomous parking or autonomous exit from parking of the vehicle, operating a motor in a brake-applying direction to move a brake pad of the vehicle into contact with a brake disc of the vehicle, stopping, based on a current supplied to the motor reaching a preset threshold value, the operating of the motor, wherein the preset threshold value corresponds to a state at which the brake pad contacts the brake disc, and after the stopping of the operating of the motor, operating the motor in a brake-releasing direction until the brake pad is spaced apart from the brake disc by a preset clearance gap for the autonomous parking or the autonomous exit, wherein the preset clearance gap is set for the autonomous parking or the autonomous exit, wherein the preset clearance gap is smaller than a reference clearance gap, and wherein the reference clearance gap is set for a driving mode of the vehicle that is different from the autonomous parking or the autonomous exit.

The method may further comprise performing, based on the brake pad being spaced apart from the brake disc by the preset clearance gap, the autonomous parking or the autonomous exit from parking.

The method, wherein the performing of the autonomous parking or the autonomous exit from parking may comprise performing, based on a previously recorded parking maneuver algorithm or command signals received from a remote computing device, the autonomous parking or the autonomous exit from parking.

The method may further comprise while the brake pad is spaced apart from the brake disc by the preset clearance gap, determining whether a primary braking system of the vehicle has failed for braking the vehicle, and based on determining that the primary braking system has failed, performing an emergency braking to decelerate or stop the vehicle by driving the motor to press the brake pad against the brake disc.

The method may further comprise based on the autonomous exit from parking being completed without performing the emergency braking, operating the motor in the brake-releasing direction until a separation between the brake pad and the brake disc reaches the reference clearance gap.

The method may further comprise measuring, via a sensor of the vehicle, the current supplied to the motor.

The method, wherein the operating of the motor in the brake-releasing direction is performed for a preset period of time, wherein the preset period of time corresponds to a time required for a separation between the brake pad and the brake disc to reach the preset clearance gap starting from a point at which the brake pad is in contact with the brake disc.

According to the present disclosure, an apparatus of a vehicle, the apparatus may comprise a processor, and a memory storing at least one instruction that, when executed by the processor communicating with the memory, is configured to cause the apparatus to, based on a start signal for autonomous parking or autonomous exit from parking of the vehicle, operate a motor in a brake-applying direction to move a brake pad of the vehicle into contact with a brake disc of the vehicle, stop, based on a current supplied to the motor reaching a preset threshold value, the operation of the motor, wherein the preset threshold value corresponds to a state at which the brake pad contacts the brake disc, and after stopping the operating of the motor, operate the motor in a brake-releasing direction until the brake pad is spaced apart from the brake disc by a preset clearance gap for the autonomous parking or the autonomous exit, wherein the preset clearance gap is set for the autonomous parking or the autonomous exit, wherein the preset clearance gap is smaller than a reference clearance gap, and wherein the reference clearance gap is set for a driving mode of the vehicle that is different from the autonomous parking or the autonomous exit.

The apparatus, wherein the at least one instruction, when executed by the processor communicating with the memory, is configured to cause the apparatus to perform, based on the brake pad being spaced apart from the brake disc by the preset clearance, the autonomous parking or the autonomous exit from parking.

The apparatus, wherein the at least one instruction, when executed by the processor communicating with the memory, is configured to cause the apparatus to perform, based on a previously recorded parking maneuver algorithm or command signals received from a remote computing device, the autonomous parking or the autonomous exit from parking.

The apparatus, wherein the at least one instruction, when executed by the processor communicating with the memory, is configured to cause the apparatus to, while the brake pad is spaced apart from the brake disc by the preset clearance gap, determine whether a primary braking system of the vehicle has failed for braking the vehicle, and based on a determination that the primary braking system has failed, perform an emergency braking to decelerate or stop the vehicle by driving the motor to press the brake pad against the brake disc.

The apparatus, wherein the at least one instruction, when executed by the processor communicating with the memory, is configured to cause the apparatus to, based on the autonomous exit from parking being completed without performing the emergency braking, operate the motor in the brake-releasing direction until a separation between the brake pad and the brake disc reaches the reference clearance gap.

The apparatus, wherein the at least one instruction, when executed by the processor communicating with the memory, is configured to cause the apparatus to measure, via a sensor of the vehicle, the current supplied to the motor.

The apparatus, wherein the at least one instruction, when executed by the processor communicating with the memory, is configured to cause the apparatus to operate the motor in the brake-releasing direction for a preset period of time, wherein the preset period of time corresponds to a time required for a separation between the brake pad and the brake disc to reach the preset clearance gap starting from a point at which the brake pad is in contact with the brake disc.

According to the present disclosure, an apparatus of a vehicle, the apparatus may comprise an electric motor, a brake pad configured to be moved by the electric motor toward a brake disc to generate braking force, the brake disc configured to rotate with a wheel of the vehicle, and a processor circuit configured to, drive, based on a signal initiating autonomous parking or autonomous parking exit, the electric motor to move the brake pad into contact with the brake disc, based on a signal indicating a contact between the brake pad and the brake disc, stop the electric motor, after the contact, drive the electric motor in a reverse direction to separate the brake pad from the brake disc by a preset clearance gap for the autonomous parking or the autonomous parking exit, and during the autonomous parking or the autonomous parking exit, based on the brake pad being separated from the brake disc by the preset clearance gap, drive the electric motor to press the brake pad against the brake disc to decelerate or stop the vehicle.

The apparatus, wherein the processor circuit is further configured to, determine, based on a signal indicating insufficient hydraulic pressure or lack of expected deceleration during the autonomous parking or the autonomous parking exit, that a braking operation associated with a hydraulic pump has failed, and based on the braking operation associated with the hydraulic pump being failed, drive the electric motor to press the brake pad against the brake disc to decelerate or stop the vehicle.

The apparatus, wherein the preset clearance gap between the brake pad and the brake disc is less than a reference clearance gap, and wherein the reference clearance gap is set for a driving mode of the vehicle that is different from the autonomous parking or the autonomous parking exit.

The apparatus, wherein the processor circuit is configured to maintain the brake pad being separated from the brake disc by the preset clearance gap within a preset duration, and wherein the preset duration is set to enable emergency braking during autonomous parking or autonomous parking exit.

The apparatus, wherein the processor circuit is further configured to drive the electric motor in the reverse direction for a preset time period to separate the brake pad from the brake disc by the preset clearance gap, wherein the preset time period corresponds to a time required to separate the brake pad from the brake disc by the preset clearance gap.

The apparatus, wherein the processor circuit is further configured to, based on completion of the autonomous parking or the autonomous parking exit without performing emergency braking, drive the electric motor in the reverse direction to increase a clearance gap between the brake pad and the brake disc to a reference clearance gap that is greater than the preset clearance gap.

The effects of the present disclosure are not limited to the effects mentioned above, and other effects not mentioned will be clearly understood by those skilled in the art from the following description.

### BRIEF DESCRIPTION OF THE DRAWINGS

FIG. 1 shows an example of an emergency braking apparatus according to one example of the present disclosure.

FIG. 2 shows an exemplary scenario in which a vehicle is decelerated when an obstacle is detected during autonomous parking, in a vehicle equipped with an emergency braking apparatus according to one example of the present disclosure.

FIG. 3 shows an example of a method performed by the emergency braking apparatus according to one example of the present disclosure.

FIG. 4A shows an exemplary process of releasing the braking force of an EPB system when an autonomous parking function is activated.

FIG. 4B shows an exemplary process of releasing the braking force of the EPB system when an autonomous parking function is activated, in a case where the emergency braking apparatus according to one example of the present disclosure is applied.

FIG. 5A shows an example of a time required for a brake pad to come into close contact with a brake disc in order to generate braking force in the EPB system according to the related art.

FIG. 5B shows an example of a time required for a brake pad to come into close contact with a brake disc in order to generate braking force of the EPB system, in a case where the emergency braking apparatus according to one example of the present disclosure is applied.

FIG. 6 shows an exemplary computing device which may be used to implement a method or an apparatus according to the present disclosure.

FIG. 7 is a block diagram schematically showing an exemplary vehicle system that may be used to implement the method or apparatus described in the present disclosure.

### DETAILED DESCRIPTION

Hereinafter, various examples of the present disclosure will be described in detail with reference to the accompanying drawings. In the following description, like reference numerals designate like elements, although the elements are shown in different drawings. Furthermore, for clarity and for brevity, the following description of various examples will omit a detailed description of related known components and functions when considered obscuring the subject of the present disclosure.

Various ordinal numbers or alpha codes such as first, second, i), ii), a), b), etc., are prefixed solely to differentiate one component from the other but not to imply or suggest the substances, order, or sequence of the components. Throughout the present specification, when a part “includes” or “comprises” a component, the part is meant to further include other components, to not exclude thereof unless specifically stated to the contrary. The terms such as “unit,” “module,” and the like refer to units in which at least one function or operation is processed and they may be implemented by hardware, software, or a combination thereof.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of emergency braking) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.). One or more auxiliary devices (e.g., engine brake, exhaust brake, hydraulic retarder, electric retarder, regenerative brake, etc.) may also be controlled, for example, based on one or more features (e.g., features of emergency braking) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of emergency braking) described herein.

Minimum risk maneuver (MRM) operation(s) may also be controlled, for example, based on one or more features (e.g., features of emergency braking) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of emergency braking) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of emergency braking) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

The description of the present disclosure to be presented below in conjunction with the accompanying drawings is directed to describe examples of the present disclosure and is not intended to represent the only examples in which the technical idea of the present disclosure may be practiced.

The present disclosure relates to a method and an apparatus for emergency braking during autonomous parking. Specifically, the present disclosure provides a technique for pre-adjusting a clearance between a brake pad and a brake disc for emergency braking using an electronic parking brake (e.g., an EPB system with a motorized actuator, an integrated brake control ECU, or a rear-wheel-only braking system, etc.) when a primary braking system fails during autonomous parking.

In the present specification, the ‘autonomous parking’ should be understood as a term that includes not only the autonomous parking but also autonomous unparking or autonomous departure from a parking space (e.g., reversing out of a parking stall, exiting a parallel parking spot, or pulling forward from a garage, etc.).

In the present specification, an electronic parking brake (EPB) system will be described as an example of an auxiliary system for emergency braking in the event of a failure of a primary braking system. This is for the sake of convenience in explanation, and is not intended to limit the scope of the present disclosure. Any braking system that uses an electric motor, such as an electro-mechanical brake (EMB), an electric wedge brake, or a cable-pull actuator driven by a motor, etc., may be utilized as the auxiliary system for emergency braking.

The EPB system is a device that electronically controls an operation of a parking brake. The EPB system provides a parking braking force to rear wheels of a vehicle, and includes an EPB actuator and an EPB Electronic Control Unit (ECU) for this purpose. The EPB actuator is a mechanical device that generates the parking braking force to the rear wheels in accordance with a control signal of the EPB ECU, and includes a motor and a reducer (e.g., a gear train, a worm gear, or a planetary reducer, etc.). The EPB system generates the parking braking force on the rear wheels by rotating the motor in the forward direction (e.g., to push the brake pad against the brake disc). The EPB system releases the parking braking force applied to the rear wheels by rotating the motor in the reverse direction (e.g., to retract the brake pad away from the disc and restore clearance).

The EMB system is a device in which an actuator driven by an electric motor is mounted on a brake caliper, enabling the vehicle to be braked directly by a motor's driving force without using an intermediate medium such as brake fluid. The EMB system may be applied to all wheels of the vehicle (e.g., front wheels, rear wheels, or all four wheels in a fully electric brake-by-wire system, etc.).

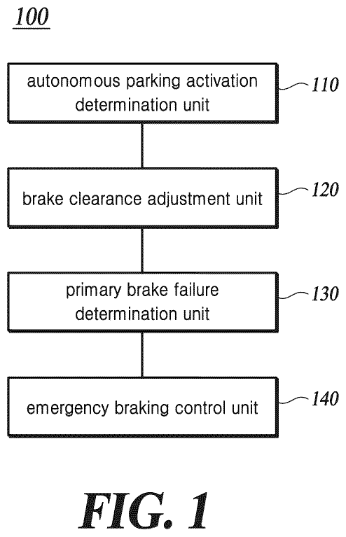

FIG. 1 shows an example of an emergency braking apparatus using an electronic parking brake during autonomous parking according to one example of the present disclosure.

Referring to FIG. 1, an emergency braking apparatus (100) according to one example of the present disclosure may include all or some of an autonomous parking activation determination unit (110), a brake clearance adjustment unit (120), a primary braking failure determination unit (130), and an emergency braking control unit (140). All blocks illustrated in FIG. 1 are not essential components, and some blocks included in the emergency braking apparatus (100) in other examples may be added, changed, or deleted. Meanwhile, the components illustrated in FIG. 1 represent functionally distinct elements, and at least one of the components may be implemented in a form in which at least one or more components are integrated with each other in an actual physical environment (e.g., integration of the brake clearance adjustment unit with the EPB ECU, or integration of the failure detection and emergency braking logic within a shared microcontroller).

The emergency braking apparatus (100) is installed within the vehicle, and may be implemented as an Electronic Control Unit (ECU). The emergency braking apparatus (100) may include at least one processor and a memory, and commands and data to be executed by the at least one processor may be stored in the memory (e.g., flash memory, DRAM, or EEPROM, etc.).

The emergency braking apparatus (100) may be integrated into the ECU of the autonomous parking system or the EPB ECU. Here, the autonomous parking system may include a Memory Parking Assist (MPA) system (e.g., a vehicle may be automatically parked based on a previously recorded parking maneuver), a Remote Smart Parking Assist (RSPA) system (e.g., a vehicle may be remotely moved in or out of a parking space via command signals transmitted by a remote controller), or a Remote Parking Pilot (RPP) system (e.g., Hyundai Smart Park, Tesla Summon, or BMW Remote Control Parking, etc.).

The emergency braking apparatus (100) may be implemented as a separate ECU, and may transmit or receive signals or data using various in-vehicle communication protocols with the autonomous parking system ECU, the EPB ECU, and the primary braking system. Here, the various in-vehicle communication protocols may include at least one of a Controller Area Network (CAN), a CAN with a flexible data rate (CAN FD), a Local Interconnect Network (LIN), FlexRay, and the Ethernet (e.g., 100BASE-T1 Ethernet, CAN FD for real-time braking data, or LIN for low-priority diagnostics, etc.).

The autonomous parking activation determination unit (110) may determine whether the autonomous parking system is entering an autonomous parking mode. When a start signal for autonomous parking or autonomous unparking (e.g., departure from a parking space) is received, the autonomous parking activation determination unit (110) may determine that the autonomous parking system is entering autonomous parking mode.

The autonomous parking system includes various operating modes, such as a standby mode and an autonomous parking mode. In the standby mode, if a drivable path is available, the vehicle is in a stationary state, and no faults are detected, the autonomous parking system activates a button or a switch for starting autonomous parking or autonomous unparking. A start signal for autonomous parking or autonomous unparking is generated when a driver operates the activated button or switch. The generated start signal may be transmitted to the emergency braking apparatus, the autonomous parking system, and the EPB (e.g., via a CAN message, wireless input from a key fob, or a touchscreen command, etc.).

The brake clearance adjustment unit (120) pre-adjusts a clearance between the brake pad and the brake disc upon determining that the autonomous parking system is entering autonomous parking mode, and before the autonomous parking operation is performed. The reason is as follows. This is intended to shorten a brake engagement time—that is, the time required for the brake pad to come into close contact with the brake disc—thereby improving the responsiveness of emergency braking using the EPB system during autonomous parking or autonomous departure from a parking space (e.g., in tight parking lots, underground garages, or parallel parking situations, etc.)

The brake clearance adjustment unit (120) may pre-adjust the clearance between the brake pad and the brake disc through processes of generating and releasing the braking force of the EPB system while the vehicle is in a stationary state (e.g., by commanding a forward actuation of the EPB motor until a threshold current is reached, and then reversing slightly to establish the clearance, etc.).

The brake clearance adjustment unit (120) may determine whether the braking force of the EPB system is being applied or has been released, in response to receiving a start signal for autonomous parking or autonomous departure from a parking space (e.g., based on the EPB actuator's position sensor, current consumption profile, or braking status flag, etc.).

The brake clearance adjustment unit (120), in response to determining that the braking force of the EPB system has been released, operates the motor of the EPB system in a brake-applying direction to bring the brake pad into close contact with the brake disc. Conversely, in response to determining that the braking force of the EPB system is being applied, the brake clearance adjustment unit (120) operates the motor of the EPB system in a brake-releasing direction to separate the brake pad from the brake disc (e.g., to reduce drag, avoid unnecessary motor load, or prepare for vehicle movement, etc.).

The brake clearance adjustment unit (120) stops the operation of the motor in response to the current supplied to the motor reaching a preset current value. The emergency braking apparatus (100) may further include a sensor (e.g., an ammeter, current-sense resistor, or Hall-effect sensor, etc.) for measuring the current intensity supplied to the motor, and the brake clearance adjustment unit (120) may obtain the measured current intensity through the sensor. Here, the preset current value refers to the current intensity at which the brake pad is in close contact with the brake disc. The preset current value may be determined in advance through theoretical calculations or experiments and may vary depending on the EPB system. For example, the preset current value may range from 5 A (Ampere) to 6 A, depending on hardware tolerances or environmental conditions (e.g., temperature, pad wear, or caliper stiffness, etc.).

The brake clearance adjustment unit (120) adjusts the brake pad to be spaced apart from the brake disc by a preset clearance. To achieve this, the brake clearance adjustment unit (120) may operate the motor in the brake-releasing direction so that the brake pad is spaced apart from the brake disc by the preset clearance. Here, the preset clearance is set to be smaller than a reference clearance between the brake pad and the brake disc in a state where the braking force of the EPB system is fully released. The preset clearance refers to a minimum clearance between the brake pad and the brake disc that does not interfere with vehicle movement during autonomous parking or autonomous departure from a parking space (e.g., forward exit, reverse exit, or tight-angle maneuvering, etc.). The preset clearance may be determined in advance through theoretical calculations or experiments, and may vary for example, based on the EPB system (e.g., based on a gear reduction ratio, a motor response delay, or pad rebound behavior, etc.), an ambient temperature of the vehicle, a load condition of the vehicle, etc.

The brake clearance adjustment unit (120) may operate the motor in the brake-releasing direction only for a preset period of time. Here, the preset period refers to the time required for the clearance between the brake pad and the brake disc to reach the preset clearance, starting from the point at which the brake pad is in close contact with the brake disc. The preset period may be determined in advance through theoretical calculations or experiments, and may vary depending on the EPB system. For example, the preset period may be 20 ms, 50 ms, or 100 milliseconds, depending on system configuration (e.g., motor power, vehicle type, or calibration profile, etc.).

The primary braking failure determination unit (130) determines whether a failure has occurred in the primary braking system of the vehicle. The primary braking failure determination unit (130) may monitor an operating status of the primary braking system or receive a signal indicating the operating status to determine whether a failure has occurred (e.g., based on brake fluid pressure, wheel speed mismatch, or missing brake pedal signal, etc.). The primary braking system is primarily responsible for decelerating or stopping the vehicle under normal conditions, whereas the emergency braking system may be configured to safely decelerate or stop the vehicle in the event that the primary braking system fails or does not operate normally. The primary braking system may include a hydraulic braking system (e.g., hydraulic actuator, hydraulic pump, hydraulic piston, hydraulic cylinder, hydraulic valve, etc.), but is not limited thereto. The emergency braking system may include an EPB system or an EMB system (e.g., with integrated spindle actuators, floating caliper designs, or motorized screw actuators, etc.).

The emergency braking control unit (140) performs emergency braking to decelerate or stop the vehicle using the electronic parking brake system in response to determining that the primary braking system has failed. When the primary braking system is operating normally, deceleration or stopping of the vehicle is carried out through the primary braking system (e.g., via driver pedal input, adaptive cruise control, or collision mitigation systems, etc.).

The emergency braking apparatus (100) may operate the motor in the brake-releasing direction until the clearance between the brake pad and the brake disc reaches the reference clearance, in the case where autonomous unparking (departure from a parking space) is completed without emergency braking being performed by the EPB system (e.g., after a successful remote exit, driver-initiated parking exit, or scheduled departure event, etc.).

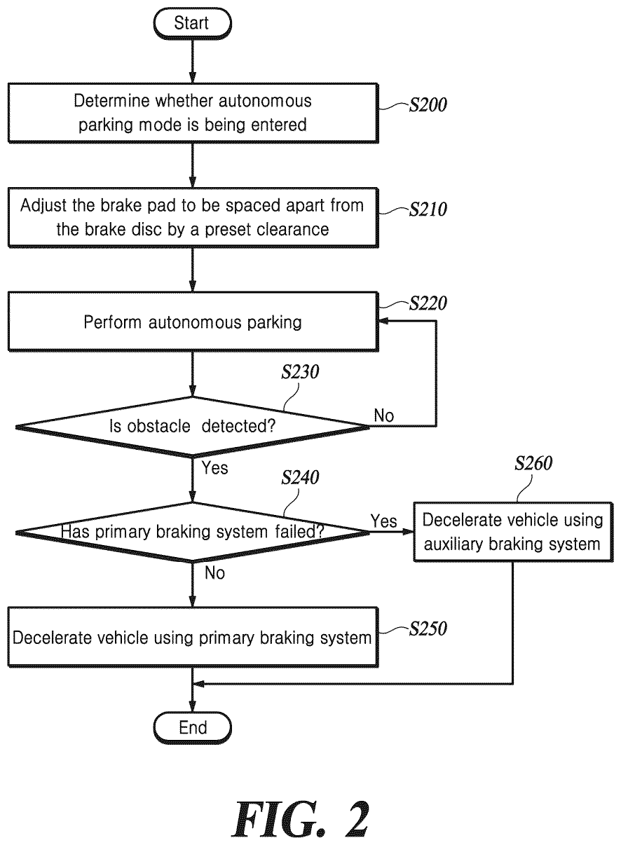

FIG. 2 shows an exemplary scenario in which the vehicle is decelerated when an obstacle is detected during the autonomous parking, in the vehicle equipped with an emergency braking apparatus according to one example of the present disclosure (e.g., deceleration due to a pedestrian, curb, or another parked vehicle, etc.).

Referring to FIG. 2, the emergency braking apparatus (100) determines whether the autonomous parking system is entering autonomous parking mode (S200). The emergency braking apparatus (100) may determine that the autonomous parking system is entering autonomous parking mode when a start signal for autonomous parking or autonomous unparking (departure from a parking space) is received while the vehicle is in a stationary state.

The emergency braking apparatus (100) adjusts the brake pad to be spaced apart from the brake disc by a preset clearance (S210). The emergency braking apparatus (100) may pre-adjust the clearance between the brake pad and the brake disc by performing the braking and releasing operations of the EPB system while the vehicle is in a stationary state. Here, the preset clearance refers to a minimum distance between the brake pad and the brake disc that does not affect vehicle movement during autonomous parking or autonomous departure from a parking space (e.g., typically less than 1.5 mm depending on system configuration, pad wear, or actuator type, etc.).

The emergency braking apparatus (100) performs autonomous parking or autonomous unparking (departure from a parking space) of the vehicle using the autonomous parking system (S220). The autonomous parking or unparking is performed after the brake pad is spaced apart from the brake disc by the preset clearance (e.g., allowing smooth vehicle motion without unintended braking resistance, etc.).

The emergency braking apparatus (100) determines whether an obstacle is detected on the driving path during autonomous parking or autonomous unparking (S230) (departure from a parking space). When an obstacle is detected, the emergency braking apparatus (100) may perform braking to decelerate the vehicle. When no obstacle is detected, the emergency braking apparatus (100) may continue to perform autonomous parking or autonomous unparking (departure from a parking space) using the autonomous parking system (e.g., until reaching a designated parking position, a boundary line, or user-defined stop point, etc.).

The emergency braking apparatus (100) determines whether a failure has occurred in the primary braking system when an obstacle is detected (S240) (e.g., due to low brake fluid pressure, sensor malfunction, or no response to deceleration commands, etc.).

The emergency braking apparatus (100) decelerates the vehicle using the primary braking system when the primary braking system is operating normally (S250) (e.g., hydraulic braking activated via pedal signal, or automated braking triggered by driver assistance functions, etc.).

The emergency braking apparatus (100) decelerates the vehicle using the auxiliary braking system when the primary braking system has failed or is operating abnormally (S260). The auxiliary braking system includes an EPB system or an EMB system (e.g., electromechanical calipers, integrated EPB actuators, or motor-driven screw-type brakes, etc.).

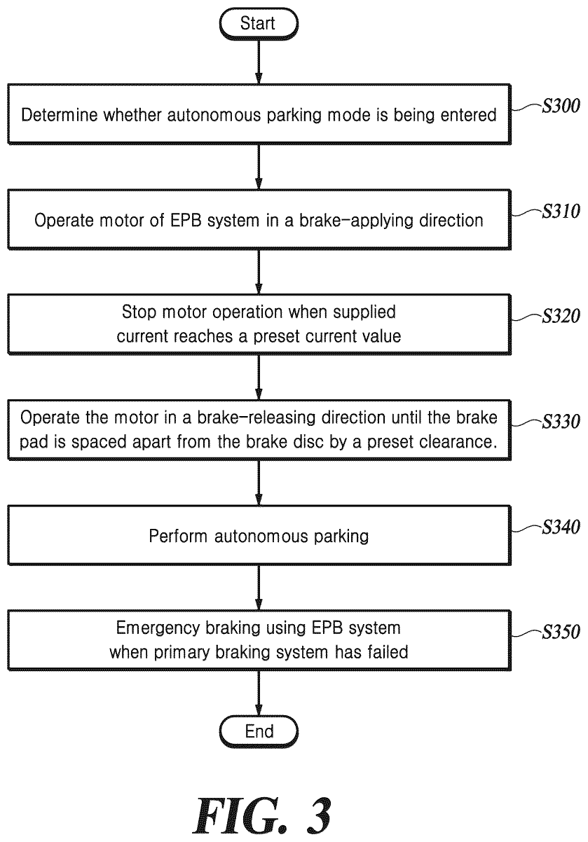

FIG. 3 shows an example of a method performed by the emergency braking apparatus according to one example of the present disclosure (e.g., for handling parking automation with redundancy and fast-response braking, etc.).

Referring to FIG. 3, the method determines whether the autonomous parking system is entering autonomous parking mode (S300). The method may determine that the autonomous parking system is entering autonomous parking mode when a start signal for autonomous parking or autonomous unparking (departure from a parking space) is received.

When it is determined that the autonomous parking system is entering autonomous parking mode, the method pre-adjusts the clearance between the brake pad and the brake disc before autonomous parking is performed. The method may pre-adjust the clearance between the brake pad and the brake disc by performing the braking and releasing operations of the EPB system while the vehicle is in a stationary state (e.g., as part of a startup procedure for memory parking, remote smart parking, or user-initiated exit, etc.).

Specifically, the method may determine whether the braking force of the EPB system is being applied or has been released (e.g., by monitoring actuator position, current sensor feedback, or EPB system status flags, etc.).

The method operates the motor of the EPB system in a brake-applying direction to bring the brake pad into close contact with the brake disc when it is determined that the braking force of the EPB system has been released (S310). The method operates the motor of the EPB system in the brake-releasing direction to separate the brake pad from the brake disc when it is determined that the braking force of the EPB system is being applied (e.g., to establish an optimized clearance before movement begins, or to reduce unnecessary motor load, etc.).

The method stops the operation of the motor when the current intensity supplied to the motor reaches a preset current value (S320). Here, the preset current value refers to the current intensity at which the brake pad is in close contact with the brake disc (e.g., typically 5 A to 6 A depending on brake type, pad wear level, or motor calibration, etc.).

The method operates the motor in a brake-releasing direction until the brake pad is spaced apart from the brake disc by the preset clearance (S330). Here, the preset clearance refers to a minimum clearance between the brake pad and the brake disc that does not interfere with vehicle movement during autonomous parking or unparking (departure from a parking space), and it is set to be smaller than the reference clearance in a fully released state of the EPB system. This helps shorten the brake engagement time, that is, the time it takes for the brake pad to come into close contact with the brake disc, thereby improving the responsiveness of the emergency braking using the EPB system during autonomous parking or autonomous departure from a parking space (e.g., enabling safe operation in tight drive-out conditions, or when reacting to a sudden obstacle, etc.).

The method performs autonomous parking or unparking (departure from a parking space) of the vehicle using the autonomous parking system (S340).

The method performs emergency braking to decelerate or stop the vehicle using the electronic parking brake system, in response to determining that the primary braking system has failed in a situation where braking is required (S350). Such a situation requiring braking of the vehicle may include cases where an obstacle is detected on the driving path during autonomous parking or departure from a parking space, where the vehicle needs to be stopped upon completion of autonomous parking or departure from a parking space, or where an interruption occurs during the execution of autonomous parking or departure from a parking space, resulting in the autonomous parking system being deactivated (e.g., due to sensor fault, sudden user override, or interruption in autonomous mode execution, etc.).

The method may operate the motor in the brake-releasing direction until the clearance between the brake pad and the brake disc reaches the reference clearance, in the case where autonomous unparking is completed without emergency braking being performed by the EPB system. That is, the pre-adjusted clearance between the brake pad and the brake disc is re-adjusted to the reference clearance (e.g., for consistent pad retraction and minimal residual torque on the wheel, etc.).

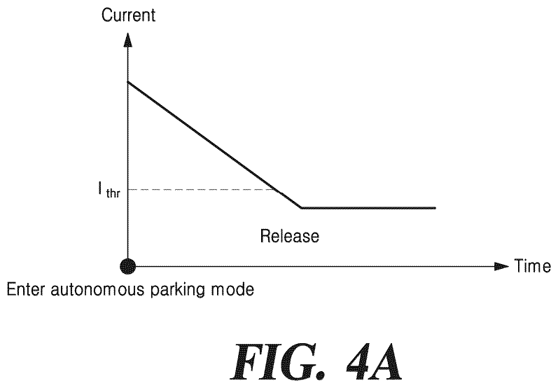

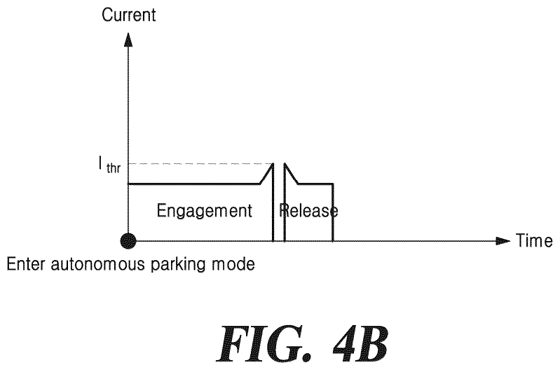

FIG. 4A shows an exemplary process of releasing the braking force of the EPB system when the autonomous parking function is activated. Referring to FIG. 4A, changes in the current intensity associated with the release of the parking braking force in the EPB system are shown. Specifically, when the autonomous parking function is activated, the current supplied to the EPB system decreases to a certain threshold value (I_{tch}), at which point the braking force is released (e.g., as part of a brake release sequence initiated by the autonomous parking controller, or after detecting the vehicle is in a ready-to-move state, etc.). After that, the current remains at a constant level. In the EPB system, the braking force may be estimated based on the current intensity, and changes in current indicate corresponding changes in braking force. Iₜₕᵣ represents the current intensity at which the brake pad comes into close contact with the brake disc (e.g., when a mechanical stop or a force threshold is detected, etc.).

FIG. 4B shows an exemplary process of releasing the braking force of the EPB system upon entry into the autonomous parking mode, in a case where the emergency braking apparatus according to one example of the present disclosure is applied. Referring to FIG. 4B, changes in the current intensity corresponding to the pre-adjustment of the brake clearance, that is, the generation, holding, and release of parking braking force in the EPB system are shown (e.g., showing a spike during initial pad contact, a plateau during holding, and a controlled drop during clearance adjustment, etc.). In this example, braking force is first applied until the brake pad comes into close contact with the brake disc. Then, the braking force is released so that the brake pad is separated from the brake disc by a preset clearance. This two-step process allows for more responsive emergency braking during autonomous parking or departure from a parking space (e.g., improving brake response from 0.7 seconds to 0.1 seconds, enabling faster safe speeds during automation, etc.).

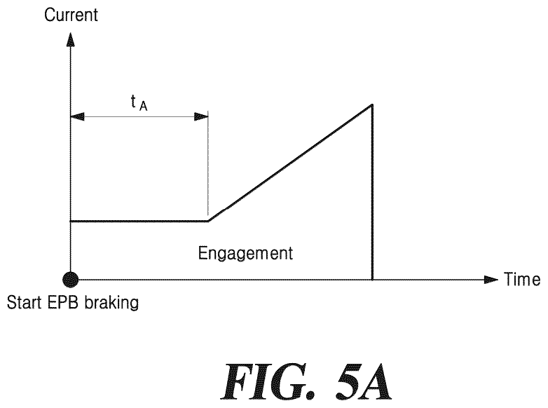

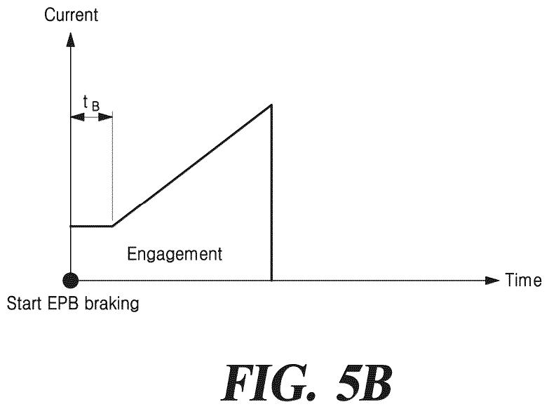

FIG. 5A shows an example of a time required for the brake pad to come into close contact with the brake disc in order to generate braking force in the EPB system. FIG. 5B shows an example of a time required for the brake pad to come into close contact with the brake disc in order to generate braking force in the EPB system, in a case where the emergency braking apparatus according to one example of the present disclosure is applied (e.g., under the same vehicle conditions such as temperature, system voltage, and pad wear level, etc.).

Referring to FIGS. 5A and 5B, it can be seen that, when the emergency braking apparatus according to one example of the present disclosure is applied, the time (t_{B}) required for the brake pad to come into close contact with the brake disc is shorter than the time (t_{A}) required in other examples. When the emergency braking apparatus (100) is applied, it becomes possible to set a deceleration start time using the EPB more quickly in a redundancy situation, enabling fast braking and allowing for increased driving speed during autonomous parking (e.g., to improve flow in automated parking garages or tight urban street parking scenarios, etc.).

For example, consider a case in which the vehicle must come to a stop within 5 meters from the point of obstacle detection. Under such a condition, the allowable driving speed during autonomous parking can be compared. In other examples, it took approximately 0.7 seconds for the brake pad to come into contact with the brake disc, limiting the autonomous parking speed to no more than 11.7 km/h. However, when the emergency braking apparatus according to an example of the present disclosure is applied, this contact time can be reduced to about 0.1 seconds, thereby allowing the autonomous parking speed to increase to up to 15.25 km/h(e.g., enabling smoother and faster entry into standard parking slots, diagonal spots, or confined reverse-in spaces, etc.).

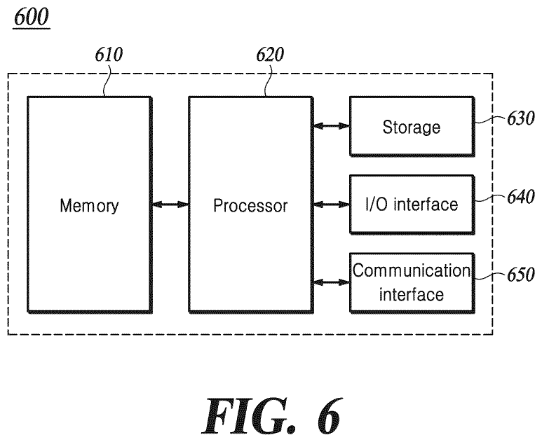

FIG. 6 shows an exemplary computing device which may be used to implement a method or an apparatus according to the present disclosure (e.g., for handling EPB actuation logic, vehicle state monitoring, or redundancy management, etc.).

The computing device (600) may include some or all of a memory (610), a processor (620), storage (630), an input/output interface (640), and a communication interface (650). The computing device (600) may structurally and/or functionally include at least a portion of the emergency braking apparatus (100). The computing device (600) may be a stationary computing device, such as a desktop computer or a server, as well as a mobile computing device, such as a laptop computer, a smartphone, an automotive electronic device, and the like (e.g., an embedded control unit, a telematics module, or a parking ECU, etc.). The computing device (600) may be implemented with any specialized hardware accelerator capable of efficiently processing operations for an artificial intelligence model. For example, the computing device (600) may include a graphic processing unit (GPU), a Tensor Processing Unit (TPU), or a neural processing unit (NPU).

The memory (610) may store the vehicle information and the parking space recognition information (e.g., vehicle dimensions, sensor map data, or historical parking trajectories, etc.). The memory (610) may store a program that causes the processor (620) to perform a method or an operation according to various examples of the present disclosure. As an example, the program may include a plurality of instructions executable by the processor (620), and the above-described method or the above-described operation may be performed by causing the processor (620) to execute the plurality of instructions (e.g., clearance adjustment routines, failure detection logic, or emergency braking triggers, etc.). The memory (610) may be a single memory or a plurality of memories. In this case, information required for performing the method or the operation according to various examples of the present disclosure may be stored in the single memory, or may be divided and stored in the plurality of memories (e.g., separating control parameters, firmware code, and sensor data buffers across physical memory devices, etc.). When the memory (610) includes the plurality of memories, the plurality of memories may be physically separated. The memory (610) may include at least one of a volatile memory and a nonvolatile memory. The volatile memory includes a static random access memory (SRAM) or a dynamic random access memory (DRAM), and the nonvolatile memory includes a flash memory, and the like (e.g., eMMC or UFS modules, etc.).

The processor (620) may include at least one core which may execute at least one instruction. The processor (620) may execute instructions stored in the memory (610). The processor (620) may be a single processor or a plurality of processors (e.g., multi-core ARM SoCs, automotive-grade MCUs, or RISC-based cores, etc.).

The storage (630) maintains stored data even when power supplied to the computing device (600) is cut off. For example, the storage (630) may include a nonvolatile memory, and may include storage media such as a magnetic tape, an optical disk, and a magnetic disk (e.g., for long-term logs, firmware backups, or configuration files, etc.). A program stored in the storage (630) may be loaded into the memory (610) before being executed by the processor (620). The storage (630) may store a file written in a programming language (e.g., C, Python, or embedded C++, etc.), and a program generated from the file by a compiler or the like may be loaded into the memory (610). The storage (630) may store data to be processed by the processor (620) and/or data processed by the processor (620) (e.g., EPB clearance values, obstacle detection results, or diagnostic logs, etc.).

The input/output interface (640) may provide an interface with an input device such as a keyboard and a mouse and/or an output device such as a display device and a printer. The user may trigger causing the processor (620) to execute the program through an input device and/or may confirm a processing result of the processor (620) through the output device (e.g., by using a touchscreen, vehicle dashboard, or diagnostic console, etc.).

The communication interface (650) may provide access to an external network (e.g., an in-vehicle network, a wireless communication network, or a diagnostic service bus, etc.). The computing device (600) may communicate with other devices through the communication interface (650) (e.g., to exchange vehicle status data, receive autonomous parking commands, or transmit emergency braking events, etc.).

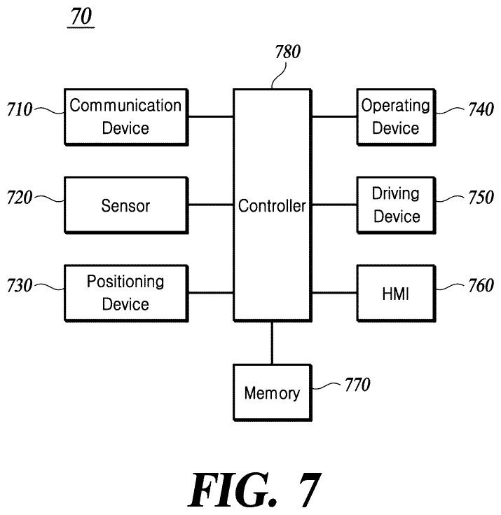

FIG. 7 is a block diagram schematically showing an exemplary vehicle system that may be used to implement the method or apparatus described in the present disclosure.

Referring to FIG. 7, the vehicle 70 includes at least one of a communication device 710, a sensor 720, a positioning device 730, an operating device 740, a driving device 750, an HMI 760, a memory 770, and a controller 780. The vehicle 70 may structurally and/or functionally include the apparatus 100. The vehicle 70 may correspond to the vehicle 100 described above.

The communication device 710 may exchange signals with devices located outside and inside the vehicle 70. The communication device 710 may exchange signals with at least one of an infrastructure device such as a server or a base station, another vehicle, and a terminal. The communication device 710 may include at least one of a transmitting antenna, a receiving antenna, an RF (Radio Frequency) circuit capable of implementing various communication protocols, and an RF element to perform communication. The communication device 710 may include an internal communication unit and an external communication unit. The internal communication unit may transmit or receive signals using various communication protocols existing within the vehicle 70. The internal communication protocol may include at least one of CAN (Controller Area Network), CAN FD (CAN with Flexible Data rate), Ethernet, LIN (Local Interconnect Network), and FlexRay. The communication protocol may include other protocols for communication between various devices mounted on the vehicle. The external communications part may communicate with other vehicles, infrastructure systems, base stations, roadside equipment, etc. using various communication protocols. The external communication protocol may include vehicle-to-vehicle (V2V) communication, vehicle-to-infrastructure (V2I) communication, vehicle-to-network (V2N) communication, and vehicle-to-everything (V2X) communication including vehicle-to-pedestrian (V2N) communication. The infrastructure may be a roadside unit or server that periodically transmits traffic information in conjunction with, for example, a Transportation Information System (TIS) or an Intelligent Transport System (ITS).

The sensor 720 may sense the status of the vehicle 70 and external objects. The sensor 720 may include at least one of an IMU (inertial measurement unit), a DMI (distance measuring instrument) device, a collision sensor, a wheel sensor, a speed sensor, an inclination sensor, a weight detection sensor, a heading sensor, a position module, a vehicle forward/backward sensor, a battery sensor, a fuel sensor, a tire sensor, a steering sensor, a temperature sensor, a humidity sensor, an ultrasonic sensor, a luminance sensor, and a pedal position sensor to sense the status of the vehicle 70. Meanwhile, the IMU sensor may include one or more of an acceleration sensor, a gyro sensor, and a magnetic sensor. The sensor 720 may generate vehicle status data, based on a signal generated from at least one sensor. For example, direction information such as heading and yaw rate of the vehicle 70 may be collected by the sensor 720.

The sensor 720 may include at least one of a camera, a radar sensor, a Light Detection and Ranging (LiDAR) sensor, an ultrasonic sensor, and an infrared sensor to detect external objects. The sensor 720 may measure at least one of information on the presence or absence of an object, information on the position of the object, information on the distance between the vehicle 70 and the object, and information on relative speed between the vehicle 70 and the object.

The positioning device 730 may generate location data of the vehicle 70. The positioning device 730 may include at least one of a Global Positioning System (GPS), a Differential Global Positioning System (DGPS), or a Global Navigation Satellite System (GNSS). The positioning device 730 may generate location data of the vehicle 70 based on a signal generated from at least one of GPS, DGPS, or GNSS. The positioning device 730 may estimate the location of the vehicle 70 based on wireless signals received from the communication device 710. The positioning device 730 may estimate the current position of the vehicle 70 based on the previous position, moving distance information, moving time information, speed information, or acceleration information of the vehicle 70 using an IMU or DMI. Meanwhile, based on the location information of the vehicle 70 collected by the positioning device 730, the controller 780 may estimate the path history and path prediction of the vehicle 70.

The operating device 740 receives user input for driving. In the manual mode or an autonomous mode (e.g., an autonomous driving mode, an autonomous parking mode, an autonomous parking exit mode, etc.), the vehicle 70 may be driven based on a signal provided by the operating device 740. The operating device 740 may include a steering input device such as a steering wheel, an acceleration input device such as an accelerator pedal, and a brake input device such as a brake pedal. The vehicle 70 may include a plurality of braking systems (e.g., a primary braking system and a secondary braking system). The secondary braking system may be an emergency braking system. One or more of the plurality of braking systems may include a hydraulic pump for braking operations, and one or more of the plurality of braking systems may include a motor (e.g., an electric motor) to adjust a clearance gap between a braking pad and a braking disc as described herein.

The driving device 750 is a device that electrically controls various vehicle driving devices within the vehicle 70. The driving device 750 may include a power train driving control device, a chassis driving control device, a door/window driving control device, a safety device driving control device, a lamp driving control device, and an air conditioning driving control device. The driving device 750 controls the movement of the vehicle 70 based on an input signal of the operating device 740 or a control signal of the controller 780.

The HMI 760 is a device for communication between the vehicle 70 and a person (e.g., a passenger of the vehicle 70 or another vehicle). The HMI 760 may receive input from a user and provide information generated in the vehicle 70 to the user. The vehicle 70 may implement a user interface (UI) or a user experience (UX) through the HMI 760. The HMI 760 may include input devices such as a touch panel, a microphone, etc., and may include output devices such as a display device, a speaker, etc. For example, the HMI 760 may include an internal display that outputs a screen toward the inside of the vehicle and/or an external display that outputs the screen toward the outside of the vehicle.

The memory 770 may store a program that causes the controller 780 to perform a method. For example, the program may include a plurality of commands executable by the processor, and a method may be performed by executing the plurality of commands using the processor.

The memory 770 may be a single memory or multiple memories. If the memory 770 is composed of the multiple memories, the multiple memories may be physically separated. The memory 770 may include at least one of volatile memory and non-volatile memory. The volatile memory includes SRAM (Static Random Access Memory) or DRAM (Dynamic Random Access Memory), and the non-volatile memory includes flash memory.

The memory 770 stores map information. The map information may be either a navigation map and/or a high definition (HD) map. The HD map may be received from the external device or may be stored in advance. The navigation map may include geographic information, road information, lane information, building information, or signal information. The HD map contains more specific data than the navigation map. The HD map may include, at the road level, information such as road slopes, road curvature, and traffic signs. The HD map may include, at the lane level, lane information, lane boundary information, stop line locations, traffic light locations, signal sequences, or intersection information. The HD map may include basic road information, surrounding environment information, detailed road environment information, or dynamic road condition information. The detailed road environment information may include static information such as terrain elevation, curvature, lanes, lane centerlines, regulatory lines, road boundaries, road centerlines, traffic signs, road markings, road shape and height, and lane width. The dynamic road condition information may include traffic congestion, accident sections, and construction sections. The HD map may include information about the surrounding road environment implemented in 3D, geometric information such as road shape or facility structure, and semantic information such as traffic signs or line marks.

The controller 780 may include at least one core capable of executing at least one command. The controller 780 may execute commands stored in the memory 770. The controller 780 may be a single processor or multiple processors.

The apparatus or method according to an example of the present disclosure may include the respective components provided to be implemented as hardware or software, or hardware and software combined. Additionally, each component may be functionally implemented by software, and a microprocessor may execute the function by software for each component when implemented.

Various illustrative implementations of the systems and methods described herein may be realized by digital electronic circuitry, integrated circuits, field-programmable gate arrays (FPGAs), application-specific integrated circuits (ASICs), computer hardware, firmware, software, and/or their combination (e.g., for real-time motor control, EPB logic execution, or sensor signal processing, etc.). These various implementations may include those realized in one or more computer programs executable on a programmable system. The programmable system includes at least one programmable processor coupled to receive and transmit data and instructions from and to a storage system, at least one input device, and at least one output device, wherein the programmable processor may be a special-purpose processor or a general-purpose processor. The computer programs (which are also known as programs, software, software applications, or code) include instructions for a programmable processor and are stored in a “computer-readable recording medium” (e.g., embedded flash, SD card, or solid-state drive, etc.).

The computer-readable recording medium includes any type of recording device on which data that can be read by a computer system are recordable. Examples of computer-readable recording mediums include non-volatile or non-transitory media such as a ROM, CD-ROM, magnetic tape, floppy disk, memory card, hard disk, optical/magnetic disk, storage devices, and the like (e.g., EEPROMs or USB storage keys, etc.). The computer-readable recording mediums may further include transitory media such as a data transmission medium. Furthermore, the computer-readable recording medium can be distributed in computer systems connected via a network, wherein the computer-readable codes can be stored and executed in a distributed mode.

Although the steps in the respective flowcharts are described to be sequentially performed, they merely instantiate the technical idea of various examples of the present disclosure. Therefore, a person having ordinary skill in the pertinent art could perform the steps by changing the sequences described in the respective flowcharts or by performing two or more of the steps in parallel, and hence the steps in the respective flowcharts are not limited to the illustrated chronological sequences e.g., clearance adjustment and parking command initiation may be executed concurrently, etc.).

In various examples of the present disclosure, each operation described above may be performed by a control device, and the control device may be configured by a plurality of control devices, or an integrated single control device (e.g., a centralized ECU or multiple distributed processors communicating via CAN or Ethernet, etc.).

In various examples of the present disclosure, the memory and the processor may be provided as one chip, or provided as separate chips (e.g., a SoC-based microcontroller or a discrete CPU and DRAM arrangement, etc.).

In various examples of the present disclosure, the scope of the present disclosure includes software or machine-executable commands (e.g., an operating system, an application, firmware, a program, etc.) for enabling operations according to the methods of various examples to be executed on an apparatus or a computer, a non-transitory computer-readable medium including such software or commands stored thereon and executable on the apparatus or the computer (e.g., automotive-grade flash memory, SD card image, or downloadable update file, etc.).

In various examples of the present disclosure, the control device may be implemented in a form of hardware or software, or may be implemented in a combination of hardware and software (e.g., using a dedicated circuit for EPB actuation and software for fault logic, etc.).

Software implementations may include software components (or elements), object-oriented software components, class components, task components, processes, functions, attributes, procedures, subroutines, program code segments, drivers, firmware, microcode, data, database, data structures, tables, arrays, and variables (e.g., a brake command queue, fault detection flag, or motor current threshold table, etc.). The software, data, and the like may be stored in memory and executed by a processor. The memory or processor may employ a variety of means well known to a person having ordinary knowledge in the art.

Furthermore, the terms such as “unit”, “module”, etc. included in the specification mean units for processing at least one function or operation, which may be implemented by hardware, software, or a combination thereof (e.g., a braking logic module, a signal filter unit, or an encoder feedback unit, etc.).

According to at least an example of the present disclosure, the present disclosure provide a method including: operating a motor of an electronic parking brake system in a brake-applying direction to bring a brake pad into close contact with a brake disc, in response to receiving a start signal for autonomous parking or autonomous unparking of a vehicle; stopping the operation of the motor when a current supplied to the motor reaches a preset current value; and operating the motor in a brake-releasing direction until the brake pad is spaced apart from the brake disc by a preset clearance.

The preset current value may be a current intensity at which the brake pad is in close contact with the brake disc.

The preset clearance may be smaller than a reference clearance which is a clearance between the brake pad and the brake disc in a fully released state of the electronic parking brake system.

The method further includes performing autonomous parking or autonomous unparking using an autonomous parking system, in response to the brake pad being spaced apart from the brake disc by the preset clearance.

The method further includes determining whether a failure has occurred in a primary braking system when braking is required, and performing emergency braking to decelerate or stop the vehicle using the electronic parking brake systemin response to determining that the primary braking system has failed.

The method further includes operating the motor in a brake-releasing direction until a clearance between the brake pad and the brake disc reaches the reference clearance, when the autonomous unparking of the vehicle is completed without emergency braking being performed by the electronic parking brake system.

The method further includes measuring the current supplied to the motor.

According to another example of the present disclosure, the present disclosure provide an apparatus for emergency braking during autonomous parking, the apparatus comprising: at least one processor; and at least one memory coupled with the at least one processor to be operable, wherein the at least one memory stores instructions that cause the at least one processor to perform operations in response to a result that the at least one processor executes the instructions, the operations comprise: operating a motor of an electronic parking brake system in a brake-applying direction to bring a brake pad into close contact with a brake disc, in response to receiving a start signal for autonomous parking or autonomous unparking of a vehicle; stopping the operation of the motor when a current supplied to the motor reaches a preset current value; and operating the motor in a brake-releasing direction until the brake pad is spaced apart from the brake disc by a preset clearance.

According to one example of the present disclosure, emergency braking responsiveness during autonomous parking can be improved.

According to one example of the present disclosure, there is an advantageous effect of enabling a higher vehicle speed during autonomous parking, thereby reducing the time required to complete the autonomous parking.

In the flowchart described with reference to the drawings, the flowchart may be performed by the controller or the processor. The order of operations in the flowchart may be changed, a plurality of operations may be merged, or any operation may be divided, and a predetermined operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an example of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the examples with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In examples of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In the present specification, unless stated otherwise, a singular expression includes a plural expression unless the context clearly indicates otherwise.

In the example of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an example of the present disclosure, components may be combined with each other to be implemented as one, or some components may be omitted.

The foregoing descriptions of specific examples of the present disclosure have been presented for purposes of illustration and description. They are not intended to be exhaustive or to limit the present disclosure to the precise forms disclosed, and obviously many modifications and variations are possible in light of the above teachings. The examples were chosen and described in order to explain certain principles of the present disclosure and their practical application, to enable others skilled in the art to make and utilize various examples of the present disclosure, as well as various alternatives and modifications thereof. It is intended that the scope of the present disclosure be defined by the Claims appended hereto and their equivalents.

What is claimed is:

1. A method performed by an apparatus of a vehicle, the method comprising:
based on receiving a start signal for autonomous parking or autonomous exit from parking of the vehicle, operating a motor in a brake-applying direction to move a brake pad of the vehicle into contact with a brake disc of the vehicle;
stopping, based on a current supplied to the motor reaching a preset threshold value, the operating of the motor, wherein the preset threshold value corresponds to a state at which the brake pad contacts the brake disc; and
after the stopping of the operating of the motor, operating the motor in a brake-releasing direction until the brake pad is spaced apart from the brake disc by a preset clearance gap for the autonomous parking or the autonomous exit, wherein the preset clearance gap is set for the autonomous parking or the autonomous exit,
wherein the preset clearance gap is smaller than a reference clearance gap, and wherein the reference clearance gap is set for a driving mode of the vehicle that is different from the autonomous parking or the autonomous exit.

2. The method of claim 1, further comprising:
performing, based on the brake pad being spaced apart from the brake disc by the preset clearance gap, the autonomous parking or the autonomous exit from parking.

3. The method of claim 2, wherein the performing of the autonomous parking or the autonomous exit from parking comprises performing, based on a previously recorded parking maneuver algorithm or command signals received from a remote computing device, the autonomous parking or the autonomous exit from parking.

4. The method of claim 2, further comprising:
while the brake pad is spaced apart from the brake disc by the preset clearance gap, determining whether a primary braking system of the vehicle has failed for braking the vehicle; and
based on determining that the primary braking system has failed, performing an emergency braking to decelerate or stop the vehicle by driving the motor to press the brake pad against the brake disc.

5. The method of claim 4, further comprising:
based on the autonomous exit from parking being completed without performing the emergency braking, operating the motor in the brake-releasing direction until a separation between the brake pad and the brake disc reaches the reference clearance gap.

6. The method of claim 1, further comprising:
measuring, via a sensor of the vehicle, the current supplied to the motor.

7. The method of claim 1, wherein the operating of the motor in the brake-releasing direction is performed for a preset period of time, wherein the preset period of time corresponds to a time required for a separation between the brake pad and the brake disc to reach the preset clearance gap starting from a point at which the brake pad is in contact with the brake disc.

8. An apparatus of a vehicle, the apparatus comprising:
a processor; and
a memory storing at least one instruction that, when executed by the processor communicating with the memory, is configured to cause the apparatus to:
based on a start signal for autonomous parking or autonomous exit from parking of the vehicle, operate a motor in a brake-applying direction to move a brake pad of the vehicle into contact with a brake disc of the vehicle,
stop, based on a current supplied to the motor reaching a preset threshold value, the operation of the motor, wherein the preset threshold value corresponds to a state at which the brake pad contacts the brake disc, and
after stopping the operating of the motor, operate the motor in a brake-releasing direction until the brake pad is spaced apart from the brake disc by a preset clearance gap for the autonomous parking or the autonomous exit, wherein the preset clearance gap is set for the autonomous parking or the autonomous exit,
wherein the preset clearance gap is smaller than a reference clearance gap, and wherein the reference clearance gap is set for a driving mode of the vehicle that is different from the autonomous parking or the autonomous exit.

9. The apparatus of claim 8, wherein the at least one instruction, when executed by the processor communicating with the memory, is configured to cause the apparatus to perform, based on the brake pad being spaced apart from the brake disc by the preset clearance, the autonomous parking or the autonomous exit from parking.

10. The apparatus of claim 9, wherein the at least one instruction, when executed by the processor communicating with the memory, is configured to cause the apparatus to perform, based on a previously recorded parking maneuver algorithm or command signals received from a remote computing device, the autonomous parking or the autonomous exit from parking.

11. The apparatus of claim 9, wherein the at least one instruction, when executed by the processor communicating with the memory, is configured to cause the apparatus to:
while the brake pad is spaced apart from the brake disc by the preset clearance gap, determine whether a primary braking system of the vehicle has failed for braking the vehicle; and
based on a determination that the primary braking system has failed, perform an emergency braking to decelerate or stop the vehicle by driving the motor to press the brake pad against the brake disc.

12. The apparatus of claim 11, wherein the at least one instruction, when executed by the processor communicating with the memory, is configured to cause the apparatus to, based on the autonomous exit from parking being completed without performing the emergency braking, operate the motor in the brake-releasing direction until a separation between the brake pad and the brake disc reaches the reference clearance gap.

13. The apparatus of claim 8, wherein the at least one instruction, when executed by the processor communicating with the memory, is configured to cause the apparatus to measure, via a sensor of the vehicle, the current supplied to the motor.

14. The apparatus of claim 8, wherein the at least one instruction, when executed by the processor communicating with the memory, is configured to cause the apparatus to operate the motor in the brake-releasing direction for a preset period of time, wherein the preset period of time corresponds to a time required for a separation between the brake pad and the brake disc to reach the preset clearance gap starting from a point at which the brake pad is in contact with the brake disc.

15. An apparatus of a vehicle, the apparatus comprising:
an electric motor;
a brake pad configured to be moved by the electric motor toward a brake disc to generate braking force;
the brake disc configured to rotate with a wheel of the vehicle; and
a processor circuit configured to:
drive, based on a signal initiating autonomous parking or autonomous parking exit, the electric motor to move the brake pad into contact with the brake disc,
based on a signal indicating a contact between the brake pad and the brake disc, stop the electric motor,
after the contact, drive the electric motor in a reverse direction to separate the brake pad from the brake disc by a preset clearance gap for the autonomous parking or the autonomous parking exit, and
during the autonomous parking or the autonomous parking exit, based on the brake pad being separated from the brake disc by the preset clearance gap, drive the electric motor to press the brake pad against the brake disc to decelerate or stop the vehicle.

16. The apparatus of claim 15, wherein the processor circuit is further configured to:
determine, based on a signal indicating insufficient hydraulic pressure or lack of expected deceleration during the autonomous parking or the autonomous parking exit, that a braking operation associated with a hydraulic pump has failed; and
based on the braking operation associated with the hydraulic pump being failed, drive the electric motor to press the brake pad against the brake disc to decelerate or stop the vehicle.

17. The apparatus of claim 15, wherein the preset clearance gap between the brake pad and the brake disc is less than a reference clearance gap, and wherein the reference clearance gap is set for a driving mode of the vehicle that is different from the autonomous parking or the autonomous parking exit.

18. The apparatus of claim 15, wherein the processor circuit is configured to maintain the brake pad being separated from the brake disc by the preset clearance gap within a preset duration, and wherein the preset duration is set to enable emergency braking during autonomous parking or autonomous parking exit.

19. The apparatus of claim 15, wherein the processor circuit is further configured to drive the electric motor in the reverse direction for a preset time period to separate the brake pad from the brake disc by the preset clearance gap, wherein the preset time period corresponds to a time required to separate the brake pad from the brake disc by the preset clearance gap.

20. The apparatus of claim 15, wherein the processor circuit is further configured to, based on completion of the autonomous parking or the autonomous parking exit without performing emergency braking, drive the electric motor in the reverse direction to increase a clearance gap between the brake pad and the brake disc to a reference clearance gap that is greater than the preset clearance gap.
